(19) United States
(12) Patent Application Publication
(10) Pub. No.: US 2018/0248423 A1
(43) Pub. Date: Aug. 30, 2018

(54) IMPROVEMENTS IN STARTER MOTORS

(71) Applicant: OPTIMAS MANUFACTURING SOLUTIONS II LLC, Houston, TX (US)

(72) Inventor: Neil Refson, St Asaph (GB)

(73) Assignee: Optimas Manufacturing Solutions II LLC, Houston, TX (US)

(21) Appl. No.: 15/757,173

(22) PCT Filed: Sep. 1, 2016
(86) PCT No.: PCT/GB2016/052704

§ 371 Date: Mar. 2, 2018

(30) Foreign Application Priority Data
Sep. 3, 2015 (GB) 1515649.0

(51) Int. Cl. H02K 1/18; F02N 11/00; H01R 39/415; H02K 5/14; H02K 15/03; H02K 15/14

(52) U.S. Cl. CPC H02K 1/185; F02N 11/00; H02K 15/14; H02K 5/148; H02K 15/03; H01R 39/415

(57) ABSTRACT

A framework is disclosed for holding magnets to provide a stator for an electric motor, in particular for a starter motor. The framework is adapted to removably receive, retain and space apart a plurality of magnets within the framework to form a tubular magnet array and provide said stator. The framework may provide a stator which is easier to assemble and more reliable than known stators. The framework provides a central aperture for receiving a rotor armature of said electric motor. The framework is arranged to be slidably inserted or removed from a housing of said electric motor. A frame portion, a stator, an electric motor, a vehicle drive assembly and a method of assembling an electric motor are also described. A brush housing comprising a plurality of passages for slidably retaining brushes and comprising a plurality of bias housings, and a brush assembly comprising the brush housing are also described.

### FIELD

The present invention relates to a framework, frame portion, stator, electric motor, vehicle drive assembly, brush housing or brush assembly for use in an electric motor and a method of assembly of an electric motor. In particular the invention relates to improvements in starter motors.

### BACKGROUND

Modern starter motors for internal combustion engines typically comprise a plurality of field magnets, typically permanent magnets, arranged in a symmetrical array on the inside of a steel housing which provides a stationary part of the starter motor, known as a stator. The steel housing is part of a magnetic circuit. A rotor armature comprising a shaft is arranged along the central axis of the steel housing inside the array of magnets to provide the rotating part of the starter motor. The rotor armature consists of steel laminations pressed onto the shaft and wound with copper wire. The armature comprises an integral commutator at one end which receives electrical current through contact with carbon brushes held against the commutator by brush springs in a brush carrier.

Such starter motors function by the interaction of an alternating induced magnetic field in the rotor armature with the permanent magnetic field of the magnet array affixed to the steel housing (the stator). The magnetic field in the rotor armature is induced by an alternating electrical current provided by the commutator which receives a direct electrical current from a battery through the brushes. The interaction of the alternating induced magnetic field of the rotor armature and the permanent magnetic field of the magnet array causes the rotor armature to rotate and drive a pinion mounted on the shaft.

### SUMMARY OF THE INVENTION

The positioning and alignment of the components of known starter motors, in particular the plurality of field magnets which are arranged as part of the stator, is critical to the performance of the starter motor. Assembly of such starter motors requires precision and can be time consuming.

In operation there is a strong magnetic force trying to pull the magnets in from the housing, so the magnets need a strong and precise mounting. This typically involves aligning the magnets with a special mounting jig and gluing them in place, or involves using spring clips spot welded onto the housing. Some starter motors comprise a very thin, non-magnetic stainless steel tube inserted and arranged on the inside diameter of the magnet array to improve the mechanical strength of the field magnet mounting. However, using such a steel tube increases the distance between the armature and the magnet array, reducing efficiency.

If the positioning of the components becomes inaccurate during manufacture, the efficiency of the motor decreases. If the mechanical strength of the mounting of the components does not remain consistently high during manufacture, failure can occur.

The position of the brush carrier is also crucial. The brushes must be held securely in the correct place to maintain efficiency and to transfer the specific electrical current to the armature. In some known starter motors, the positioning of the brushes is reliant on the accurate assembly of the outer case components, such as end caps and the housing. These components are typically finished by machining and so require significant on-going quality control.

Fitting the brush springs in the brush carrier to bear against the brushes is often a difficult and awkward operation which delays and/or complicates the assembly process of such a starter motor. If the fitting is performed by hand it is time consuming, stressful and can cause repetitive strain injuries to the manufacturer. The fitting can be performed by machines but this may significantly increase the cost and complexity of the assembly process.

It is one aim of the present invention, amongst others, to provide a framework, frame portion, stator, electric motor, vehicle drive assembly, brush housing or brush assembly for use in an electric motor, or a method of assembly of an electric motor, that addresses at least one disadvantage of the prior art, whether identified here or elsewhere, or to provide an alternative to existing frameworks, frame portions, stators, electric motors, vehicle drive assemblies or brush housings for use in an electric motor or existing methods of assembly. For instance it is an aim of the invention to provide a framework for holding magnets to provide a stator for an electric motor which is easier and/or cheaper to assemble and/or more reliable. Furthermore it is an aim of the present invention to provide a brush housing which allows an easier and/or cheaper assembly of an electric motor comprising the brush housing.

According to example embodiments, there is provided a framework, frame portion, stator, electric motor, vehicle drive assembly, brush housing or brush assembly for use in an electric motor or a method of assembly of an electric motor as set forth in the appended claims. Other features of the invention will be apparent from the dependent claims, and the description which follows.

Throughout this specification, the term “comprising” or “comprises” means including the component(s) specified but not to the exclusion of the presence of other components.

The term “consisting of” or “consists of” means including the components specified but excluding addition of other components.

Whenever appropriate, depending upon the context, the use of the term “comprises” or “comprising” may also be taken to encompass or include the meaning “consists essentially of” or “consisting essentially of”, and may also be taken to include the meaning “consists of” or “consisting of”.

The optional features set out herein may be used either individually or in combination with each other, where appropriate, and particularly in the combinations as set out in the accompanying claims. The optional features for each aspect or exemplary embodiment of the invention, as set out herein are also to be read as applicable to any other aspects or exemplary embodiments of the invention, where appropriate. In other words, the skilled person reading this specification should consider the optional features for each exemplary embodiment of the invention as interchangeable and combinable between different exemplary embodiments.

According to a first aspect of the present invention, there is provided a framework for holding magnets to provide a stator for an electric motor, wherein the framework is adapted to removably receive, retain and space apart a plurality of magnets within the framework to form a tubular magnet array adapted to accept a rotor armature arranged for rotation about a long axis of the framework, wherein the framework is arranged to slidably engage with a housing of said electric motor for insertion therein or removal therefrom.

By tubular magnet array we mean a magnet array with a hollow central portion through which passes a long axis of the array and which may be suitable for receiving said armature of an electric motor. The cross section of said tubular magnet array may be any shape. However, said cross section of said tubular magnet array is suitably circular for assembly with a substantially cylindrical armature and a substantially cylindrical housing, as in known electric motors. Suitably said tubular magnet array can function as a stator in an electric motor.

The framework of this first aspect has the advantage that assembly of an electric motor comprising the framework may be more simple and straightforward than assembly of prior art electric motors. For example, assembly of an electric motor comprising the framework may comprise a step of placing the appropriate magnets into the framework and then inserting the framework and magnets into a housing of said electric motor. This step in the method of assembly may be significantly more cost effective than assembly methods known in the prior art, such as locating the individual magnets into the housing and positioning them with spring clips and/or with glue. Any such time and cost savings in the assembly of an electric motor lead to very significant time and cost savings when multiplied over a large production run of multiple electric motor units.

The framework of this first aspect may also have the advantage of retaining said magnets in place in the event that one or more of said magnets suffer a fracture that will lead to the magnet or a piece of the magnet being displaced from its desired location in a known electric motor. Therefore the framework of this first aspect may provide a more reliable electric motor which would not need dismantling and repairing in the event of a magnet fracture.

Suitably the framework comprises a plurality of frame portions adapted to mutually interengage to form the framework.

For example, a substantially cylindrical framework may be formed from a plurality of frame portions, allowing the frame portions to be formed by moulding, for example of a polymeric material, whereas the moulding of a substantially cylindrical framework would be difficult or impossible. Therefore the framework comprising a plurality of frame portions adapted to mutually interengage to form an assembled framework may improve the ease of manufacture of the framework compared to a framework formed from a single part or piece.

The frame portions may mutually interengage to form the assembled framework by the fitting together of complimentary male and female parts, for example by snap-fitting. Alternatively the frame portions may be bolted, riveted, screwed or glued together to form the assembled framework.

Suitably the plurality of frame portions comprises two frame portions, each of the two frame portions providing approximately half of the framework.

For example a substantially cylindrical framework may be formed from two frame portions substantially equal in size, or equal in size, which interengage to form the assembled substantially cylindrical framework. The two frame portions may be substantially identical. In some embodiments the two frame portions are identical for ease of manufacture as only one type of frame portion need be provided in order for the framework to be assembled from the frame portions. For example the two frame portions may be hollow semicylinders, suitably identical hollow semicylinders.

Suitably the framework has a substantially cylindrical outer surface for sliding engagement with said housing.

Stators and electric motor housings are typically cylindrical. Therefore it is preferable that the framework has a substantially cylindrical outer surface in order to be compatible with commonly used electric motor parts such as armatures and housings. Suitably when said magnets are received in the framework, a tubular magnet, a cylindrical tubular magnet or a cylindrical stator is provided. A cylindrical shape has been found to be the favoured configuration for stators in electric motors.

Suitably said magnets are curved and the framework is adapted to receive, retain and space apart said magnets to provide said tubular magnet array retained within the framework.

The curved magnets may provide a consistent cylindrical shape to said tubular magnet array retained in the framework, to provide the favoured cylindrical shape for said stator.

Suitably the framework comprises a plurality of bays each adapted to receive, retain and space apart one of the said plurality of magnets.

The plurality of bays are suitably configured in a regular arrangement to provide the required regular arrangement of said plurality of magnets when received in the bays. The plurality of bays may allow said magnets to be placed into the framework from the outer surface of the framework, which may improve the ease of assembly of a stator incorporating the framework.

Suitably the plurality of bays are arranged to provide the optimum placement of said magnets to achieve optimum performance of a stator incorporating the framework.

Suitably the bays are tapered to narrow from an outer surface of the framework towards an inner surface of the framework.

The tapering of bays suitably prevents said magnets from passing through the bays from the outer surface of the framework, through the framework, to the inner surface of the framework and therefore allows said magnets to be retained in the bays of the framework. Said magnets may be tapered to have a narrower inside surface than the outside surface of the magnet in order to provide a complimentary fit to the tapered bays of the framework, facilitating assembly and improving retention of the magnets in the bays.

The framework and/or said magnets having the tapering described above may be particularly effective at retaining said magnets in place in the event that one or more of said magnets suffer a fracture.

Suitably said magnets engage with the bays of the framework in a close tolerance fit in order for said magnets to be held in the framework sufficiently to allow insertion of the framework and magnets into said housing.

Suitably the framework is formed from a polymeric material.

Suitable polymeric materials include polyamides, polypropylene, polyoxymethylene and bulk moulding compound (glass-fiber reinforced thermoset polyester). Forming a framework from a polymeric material may have the advantage that the framework or frame portion can be formed by moulding which may reduce the material and production costs of the stator and/or electric motor. Forming the framework from a polymeric material may also provide a lighter weight part than known stator parts.

Suitably the framework is elastically deformable.

Suitably the framework is elastically deformable by a manufacturer's hand pressure, for example so at least a portion of the framework can be elastically deformed and/or elastically displaced to permit a magnet to enter a bay of the framework and be retained therein.

Suitably the framework is elastically deformable in order to compensate for any inaccuracy of a process used to form the framework or frame portions, for example a moulding process, and/or to allow the framework to engage in close tolerance fits with, for example, the said plurality of magnets and/or other parts to which the framework is attached in the assembly of an electric motor.

Suitably the framework is shaped to accommodate elongate bolts extending substantially parallel to the long axis of the framework for assembling an electric motor incorporating the framework.

The framework may comprise elongate slots on an outer surface of the framework to accommodate said elongate bolts.

Suitably the framework comprises apertures adapted to receive one or more electrical terminals for connection to one or more brushes.

Suitably the apertures are adapted to receive one insulated terminal and one earthed terminal for connection to one or more brushes.

The framework comprising apertures adapted to receive one or more electrical terminals for connection to one or more brushes may have the advantage of reducing the number of parts required to assemble the stator and associated brush assembly in the electric motor, which may provide a cost saving and/or a more efficient assembly process.

Suitably the framework and one of the apertures adapted to receive an electrical terminal form an electrical insulator portion for an electrical terminal in order to provide an insulated electrical terminal. Suitably such an electrical insulator portion is adapted to receive an electrical terminal for connection to an electrically positive wire, in use in an assembled electric motor.

The aperture forming an electrically insulated portion for an electrical terminal may further reduce the number of parts required to assemble the stator and associated brush assembly and therefore provide a cost saving and/or a more efficient assembly process.

In embodiments wherein a substantially cylindrical framework is formed from two frame portions substantially equal in size which interengage to form the assembled substantially cylindrical framework, the two frame portions may be substantially identical apart from each of the two frame portions having a different aperture adapted to receive an electrical terminal. For example, one of the two frame portions may comprise an aperture adapted to receive an insulated electrical terminal intended to be connected to an electrically positive wire in an assembled electric motor. The other of the two frame portions may comprise an aperture adapted to receive an earthed electrical terminal intended to be connected to a housing for a stator in an assembled electric motor.

Suitably the framework comprises a brush housing. The brush housing may be arranged coaxially with the framework.

The brush housing may be a separate part to the framework and may be complimentary in shape and attachable to the framework. Alternatively the brush housing may be formed integral to the framework.

Suitably the brush housing comprises:

a central aperture adapted to receive said armature comprising an armature shaft;

a plurality of passages, each passage arranged to slidably retain a brush at least partially extending into the central aperture for contacting said armature shaft and each passage comprising at least one of a plurality of brushes; and

a plurality of bias housings, each bias housing arranged in communication with at least one of the plurality of passages through an opening and each bias housing comprising a bias arranged to urge, through the opening, the at least one of the plurality of brushes in the at least one of the plurality of passages towards said armature shaft, for contact therewith.

Suitably the central aperture provides a continuation of a central aperture in the framework. The plurality of brushes need to be biased against said armature shaft in order to complete the required circuit with said armature shaft through a commutator in order for the electrical circuit to produce the required magnetic field to interact with the plurality of magnets in the framework to provide rotation of the electric motor.

The brush housing may have the advantage that assembly of an electric motor comprising the brush housing may be more simple and straightforward than assembly of prior art electric motors, for example by enabling the brushes to be arranged in the passages, an armature shaft to then be arranged in the central aperture and then the biases to be placed in the bias housings to urge the brushes towards said armature shaft.

Suitably the bias housings are each adapted to receive a conical or frustoconical spring as the bias.

Said conical or frustoconical springs comprise a narrower end and a wider end. Suitably said conical or frustoconical springs are inserted into the bias housings so that the narrower ends are arranged to bear upon the brushes through the openings.

A conical or frustoconical spring has the advantage that compression of such springs allows the spring to be fed through a narrow slot into a wider bias housing into which the spring then expands in order to perform its function of biasing the relevant brush against said armature shaft.

Suitably each bias housing comprises a slot arranged on an outer surface of the brush housing through which a bias can be passed when compressed. Suitably the slot of the bias housing is narrower than the main body of the bias housing. Suitably the bias expands within the bias housing and cannot pass back through the slot, thereby being retained in the slot. Such an arrangement may greatly facilitate assembly compared to known brush assemblies and/or electric motors.

Suitably the brush housing comprises four passages. Suitably the passages are all arranged in the same radial plane with respect to the long axis of the central aperture.

Suitably the passages each comprise an edge arranged circumferentially with respect to the central aperture which is shorter than both an edge of the passage arranged radially with respect to the central aperture and an edge of the passage arranged along the axis of the central aperture.

Suitably the passages are arranged to receive brushes which have one shorter edge and two longer edges. Suitably the brushes are arranged in the passage to contact an armature shaft received in the central aperture through a face of the brush comprising a shorter edge.

Suitably the passages are adapted to slidably receive brushes such that said brushes are arranged radially with respect to the central aperture.

Suitably the bias housings are arranged outward from the passages with respect to the central aperture.

Suitably the bias housings are arranged so that the passages are between the bias housings and the central aperture.

This arrangement of bias housings and passages allows a bias located in the bias housings to urge a brush in an adjacent passage towards and into contact with the armature shaft in order to provide the required electrical connection.

Suitably the brush housing is formed from at least a first part and a second part and suitably the first and second parts are arranged to cooperate to retain said brushes and biases within their respective passages and bias housings.

The first part may provide open passages and bias housings and the second part may provide a cover for the open passages and the bias housings wherein connecting the first and second parts together provides the passages and bias housings. The second part may comprise, or provide when assembled with the first part, a slot for receiving a compressed bias which allows the compressed bias to pass through and subsequently expand once located in the bias housing, the slot thus preventing the expanded bias in the bias housing from being removed from the bias housing. The brush housing being formed from at least a first part and second part in this manner may allow the brush housing to be formed by moulding, for example by moulding of a polymeric material, in order to save material and production costs and to provide a lighter brush housing than brush housings found in known electric motors.

Suitably the framework comprises a plurality of brushes located in the passages; and a plurality of biases located in the bias housings.

Suitably the framework comprises four brushes located in four passages of the brush housing and four biases located in four bias housings of the brush housing. Suitably the brushes are cuboid in shape with four narrower faces and two wider faces. Suitably a narrower face of the brushes is arranged in the brush housing facing into the central aperture for contact with said armature shaft. Suitably a narrower face of the brush is arranged in the brush housing to contact the bias located in the bias housing. Suitably the narrower face of the brush arranged to contact the bias comprises a lip at one end which is arranged to prevent lateral movement of the bias in the bias housing along the axis of the central aperture and therefore prevent the bias moving out of the bias housing and out of contact with the brush.

According to a second aspect of the present invention, there is provided a frame portion adapted to interengage with at least one other frame portion in order to form a framework according to the first aspect.

The suitable features of the frame portion and the framework are as described above in relation to the first aspect.

According to a third aspect of the present invention, there is provided a stator comprising a framework according to the first aspect, the stator comprising a plurality of magnets received, retained and spaced apart within the framework to form a tubular magnet array.

The plurality of magnets may have any of the suitable features described in relation to the first aspect.

The stator of this third aspect may allow a more efficient assembly than known stators and may provide a more reliable stator as described in relation to the first aspect. The brush housing and the brushes may have any of the suitable features described in relation to the first aspect.

According to a fourth aspect of the present invention, there is provided an electric motor comprising:

a stator according to the third aspect;

a brush housing comprising brushes, and

an armature comprising an armature shaft.

The suitable features of the armature and armature shaft would be known to the skilled person.

Suitably the brush housing comprises:

a central aperture adapted to receive the armature comprising an armature shaft;

a plurality of passages, each passage arranged to slidably retain a brush at least partially extending into the central aperture for contacting the armature shaft and each passage comprising at least one of a plurality of brushes; and

a plurality of bias housings, each bias housing arranged in communication with at least one of the plurality of passages through an opening and each bias housing comprising a bias arranged to urge, through the opening, the at least one of the plurality of brushes in the at least one of the plurality of passages towards the armature shaft, for contact therewith.

According to a fifth aspect of the present invention, there is provided a vehicle drive assembly comprising an engine and an electric motor according to the fourth aspect configured as a starter motor for the engine.

Suitably the engine may be an internal combustion engine. In particular, the engine may be a spark ignition petrol combustion engine.

The engine may be a two-stroke engine, for instance a single cylinder two-stroke engine.

The engine may be a four-stroke engine, for instance a single cylinder or twin cylinder four-stroke engine. Other engine configurations such as Wankel engines or other multi-cylinder engines may be used.

According to a sixth aspect of the present invention, there is provided a method of assembling an electric motor, the method comprising the steps of:

a) providing a framework according to the first aspect and a plurality of magnets;

b) assembling a stator, comprising inserting the plurality of magnets into the framework for retention therein; and

c) after step b) sliding the assembled stator into a housing of the electric motor.

Suitably steps a), b) and c) are carried out in the order step a) followed by step b) followed by step c).

Step a) may involve forming the framework from at least two frame portions, suitably from two frame portions, suitably two hollow semicylinder frame portions.

Suitably step a) involves snap-fitting at least two frame portions together to form the framework.

The plurality of magnets may have any of the suitable features described in relation to the first aspect.

Suitably step b) involves engaging the plurality of magnets in a close tolerance fit with the framework, suitably when the framework is elastically deformable, for retention therein.

Suitably step b) involves arranging a brush housing, suitably a brush housing as described in relation to the fourth aspect, adjacent to and in contact with the framework.

Suitably step c) involves fitting an armature comprising an armature shaft into the stator. The suitable features of the armature and armature shaft would be known to the skilled person.

Suitably step c) is followed by a step of fitting a front end cap and a rear end cap to the housing and using elongate bolts to fix the front end cap, rear end cap and housing together to form the electric motor.

Suitably the framework comprises elongate slots on an outer surface of the framework to accommodate the elongate bolts.

Suitably the magnets are in an un-magnetised state during step b) and the method comprises a further step d) of magnetising the magnets after sliding the assembled stator into the housing of the electric motor.

According to a seventh aspect of the present invention, there is provided a brush housing for an electric motor, the brush housing comprising:

a central aperture adapted to receive an armature comprising an armature shaft;

a plurality of passages, each passage arranged to slidably retain a brush at least partially extending into the central aperture for contacting said armature shaft; and

a plurality of bias housings, each bias housing arranged in communication with at least one of the plurality of passages through an opening and each bias housing arranged to receive and retain a bias for urging, through the opening, said brushes towards said armature shaft.

The brush housing of this seventh aspect may have any of the suitable features of the brush housing described in relation to the fourth aspect.

Suitably each bias housing comprises a slot arranged on an outer surface of the brush housing through which a bias can be passed when compressed.

Suitably the bias housings are each adapted to receive a conical or frustoconical spring as the bias.

Suitably the passages are arranged radially with respect to the central aperture.

Suitably the bias housings are arranged outward from the passages with respect to the central aperture. Suitably the bias housings are arranged circumferentially with respect to the central aperture.

Suitably the bias housings are arranged so that the passages are between the bias housings and the central aperture.

Suitably the brush housing is formed from at least a first part and a second part and wherein the first and second parts are arranged to cooperate to retain said brushes and biases within their respective passages and bias housings.

According to an eighth aspect of the present invention, there is provided a brush assembly comprising a brush housing according to the seventh aspect; a plurality of brushes located in the passages; and a plurality of biases located in the bias housings.

According to a ninth aspect of the present invention, there is provided an electric motor comprising a brush assembly according to the eighth aspect, a stator and an armature shaft; wherein the biases bias the brushes against the armature shaft.

According to a tenth aspect of the present invention, there is provided a method of assembling an electric motor, the method comprising the steps of:

a) providing a stator or stator framework having a plurality of brush electrical terminals, each comprising a brush attached thereto;

b) locating at least a first part of a brush housing according to the seventh aspect on the stator or stator framework;

c) arranging each of the brushes in a passage of the brush housing;

d) arranging an armature in the central aperture of the brush housing;

e) arranging a bias in each of the bias housings of the brush housing such that the biases urge the brushes towards and into contact with the armature.

Suitably steps a), b), c), d) and e) are carried out in the order step a) followed by step b) followed by step c) followed by step d) followed by step e).

Suitably after step c) and before step d) there is a step of joining a first part of the brush housing to a second part of the brush housing to retain the brushes in the passages.

Suitably the biases of step e) are conical or frustoconical springs.

According to an eleventh aspect of the present invention, there is provided a framework, frame portion, stator, electric motor, vehicle drive assembly, brush housing, brush assembly or method of assembly substantially as described herein, and/or as described herein with reference to the accompanying Figures and/or as shown in the accompanying Figures.

### BRIEF DESCRIPTION OF THE DRAWINGS

For a better understanding of the invention, and to show how example embodiments may be carried into effect, reference will now be made to the accompanying drawings in which:

FIG. 1 is a perspective view of a framework (100) according to the first aspect.

FIG. 2 is a perspective view of two frame portions (200a and 200b) according to the second aspect which mutually interengage to form the framework (100) of FIG. 1.

FIG. 3 is a perspective view of the framework (100) shown in FIG. 1 comprising a plurality of magnets (120) to provide a stator (300) according to the third aspect.

FIG. 4 shows an exploded view of an electric motor (400) according to the fourth aspect and/or the ninth aspect, the electric motor comprising a stator (300) according to the third aspect, the stator comprising a framework (100) as shown in FIG. 1, and the electric motor comprising a brush housing (500) according to the seventh aspect.

FIG. 5 shows a perspective view of a fully assembled electric motor (400) of FIG. 4.

FIG. 6 shows a perspective view of a brush housing (500) for an electric motor according to the seventh aspect.

FIGS. 7a and 7b show perspective views of a first part (510) and second part (520) of a brush housing for an electric motor according to the seventh aspect, respectively.

FIG. 7c shows the first part of a brush housing (510) of FIG. 7a comprising brushes and biases.

FIG. 8 shows the brush housing (500) of FIG. 6 comprising a plurality of brushes and biases, according to the eighth aspect.

### DETAILED DESCRIPTION OF THE EXAMPLE EMBODIMENTS

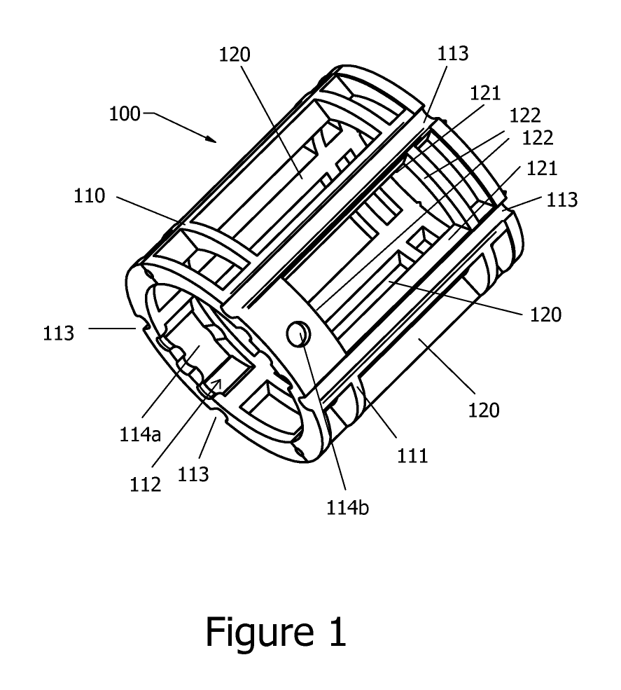

FIG. 1 shows a framework (100) according to the first aspect of the present invention. The framework (100) comprises a body (110) formed of a polymeric material, an outer surface (111) and a central aperture (112). The framework (100) comprises elongate slots (113) for receiving elongate bolts to affix the framework into an electric motor. The framework (100) also comprises an aperture (114a) for receiving an earthed electrical terminal and an aperture (114b) for receiving an insulated electrical terminal. The insulated and earthed electrical terminals provide the positive and negative electrical connections for a brush assembly which is connected to the framework in use. The body (110) is arranged such that six bays (120) are formed in the outer surface (111) of the framework (100) to each accommodate in use one of a plurality of magnets to form a tubular magnet array. The bays (120) have a pair of longer edges (121) and a pair of shorter edges (122). The longer edges (121) are tapered such that the bays (120) are wider at the outer surface (111) of the framework (100) and narrower at an inner surface of the framework (100) which forms the central aperture (112). The shorter edges (122) are not tapered and present a straight edge perpendicular to the central axis of the framework (100) which passes through the central aperture (112). The tapering of longer edges (121) and of bays (120) ensures that a magnet with a suitably complimentary shape cannot pass through the bays (120) and into the central aperture (120). The body (110) of the framework (100) is elastically deformable and arranged to engage in a close tolerance fit with a suitably complimentary shaped magnet when said magnet is placed in a bay (120) in order to retain said magnet in place during assembly and subsequent use.

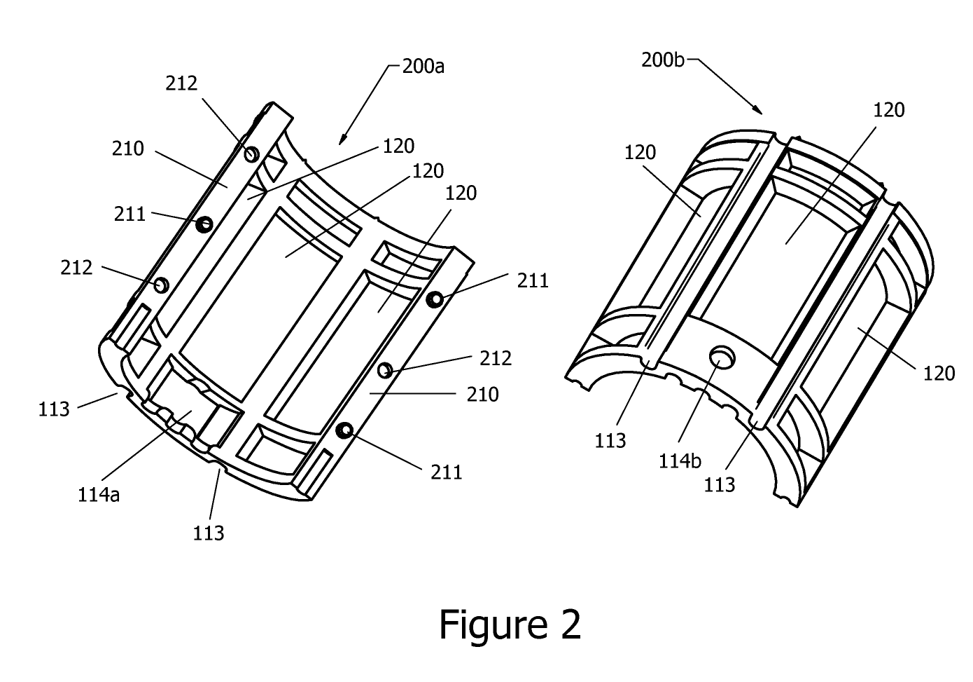

FIG. 2 shows two frame portions (200a and 200b) according to the second aspect of the invention. Each frame portion (200a and 200b) is a hollow semicylinder frame portion comprising three bays (120), two elongate slots (113) and one aperture (114a or 114b) for receiving an electrical terminal. The two frame portions (200a and 200b) shown are identical apart from the apertures (114a and 114b) which are shaped differently to accommodate either an insulated or earthed electrical terminal. The two frame portions (200a and 200b) are arranged to mutually interengage to provide a framework (100) shown in FIG. 1. The frame portions (200a and 200b) are mutually interengaged by bringing together edges (210) of one frame portion (200a) with the same edges (210) of the other frame portion (200b) in order for the male snap-fit connection parts (211) to cooperate with the female snap-fit connection parts (212) in order to hold the two frame portions (200a and 200b) together to form the framework (100). Each frame portion (200a and 200b) is made of a polymeric material by a moulding process.

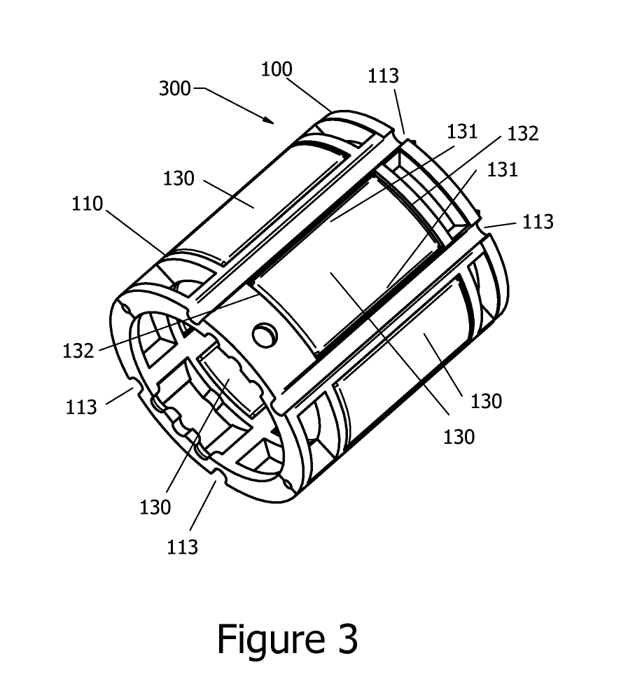

FIG. 3 shows the framework (100) of FIG. 1 comprising six magnets (130), each located in a bay (120) in the framework (100), which provides a stator (300) according to the third aspect. The magnets (130) are curved and so have a suitably complimentary shape to the bays (120). Magnets (130) comprise a pair of longer edges (131) and a pair of shorter edges (132). The longer edges (131) are tapered to match the tapering of longer edges (121) on bays (120) and the shorter edges (132) are not tapered and match the shape of the shorter edges (122) on bays (120). The magnets (130) are held in bays (120) by a close tolerance fit with the elastically deformable body (110) and are prevented from passing through bays (120) by the complimentary tapering of the bays (120) and the magnets (130). The framework (100) and magnets (130) form a tubular magnet array which is adapted to accept a rotor armature in an electric motor.

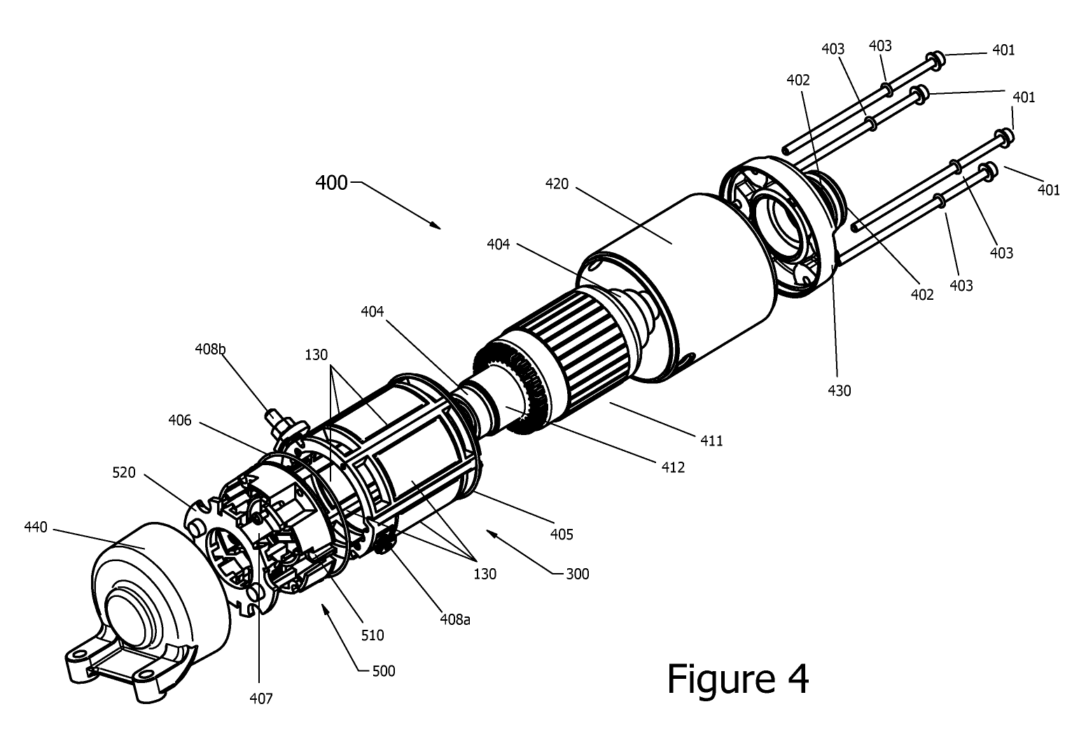

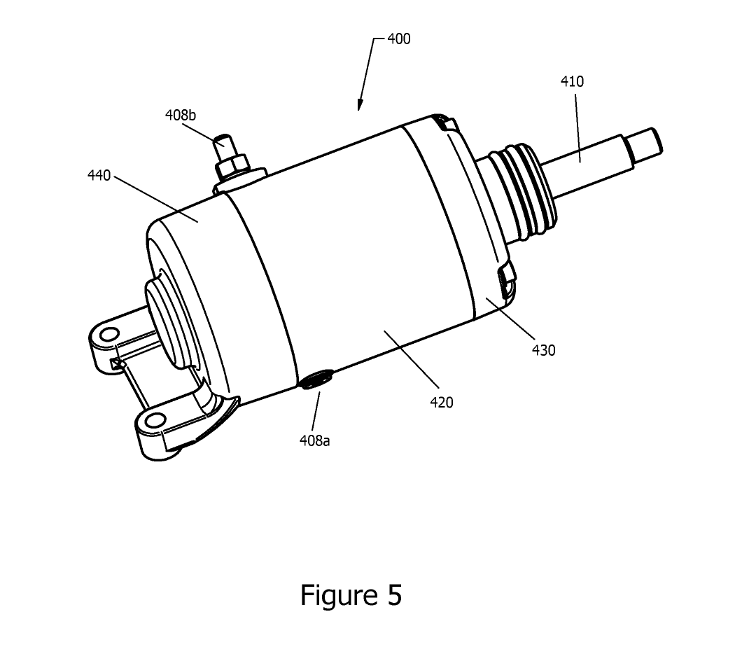

FIG. 4 shows an electric motor (400) according to the fourth aspect of the present invention. Electric motor (400) comprises stator (300), armature shaft (410, not shown, see FIG. 5), housing (420), front end cap (430). rear end cap (440) and brush housing (500). The armature shaft comprises armature windings (411) and commutator (412). The exploded view of

FIG. 4 shows how the electric motor (400) is assembled from these parts. Stator (300) engages with brush housing (500) and the central aperture of the stator (300) and the brush housing (500) receives armature shaft (410). Housing (420) receives the brush housing (500) and stator (300) and the electric motor is fixed together using elongate bolts (401) to affix the front end cap (430) to the rear end cap (440) with the housing (420) retained therebetween. O-rings (402), washers (403), bearings (404), seals (405) and (406) and bolts (407) are incorporated into electric motor assembly according to standard practice. Stator (300) receives electrical terminal assemblies (408a and 408b) in apertures (114a and 114b, see FIG. 1).

The assembly process of the electric motor (400) shown in FIG. 4 is greatly facilitated by the provision of framework (100) which allows magnets (130) to be simply placed in bays (120) of the framework (100) and retained and spaced apart therein to provide the tubular magnet array of stator (300). Stator (300) can then be simply slotted into housing (420) and the rest of the electric motor (400) assembled in a conventional fashion. The ease of assembly of the stator (300) of the electric motor (400) is much improved compared to known methods of assembling stators which involve either gluing magnets onto the inside of the housing (420) or involve welding spring clips onto housing (420) for use in receiving and retaining the magnets (130). The framework (100) also provides the advantage that a fracture, for example a longitudinal fracture, of any of magnets (130) in use, which is common with prolonged use of known electric motors, may not cause the magnet (130) to become dislodged from its bay (120). The tapering of the magnet (130) and bay (120) and the close tolerance fit of the magnet (130) into the bay (120) ensure that such a fractured magnet is retained in its bay (120). In known electric motors such a longitudinal fracture of any of magnets (130) may cause a magnet or part of a magnet to become displaced from its desired position in the stator/electric motor and therefore require the electric motor to be disassembled and repaired. Therefore the framework (100) and stator (300) may improve the longevity and reliability of an electric motor (400) over known stators and electric motors.

FIG. 5 shows a fully assembled electric motor (400) comprising armature shaft (410), housing (420), front end cap (430), rear end cap (440) and electrical terminal assemblies (408a and 408b).

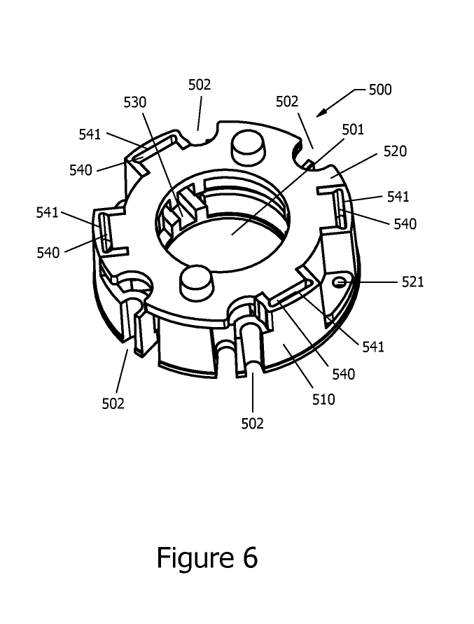

FIG. 6 shows a brush housing (500) according to the seventh aspect of the present invention. Brush housing (500) is substantially circular and comprises central aperture (501) for receiving an armature in an electric motor assembly, and elongate slots (502) for accommodating elongate bolts used to fix together said electric motor assembly. Brush housing (500) comprises four passages (530) for receiving brushes. The passages (530) are elongate channels which are arranged radially with respect to the central aperture (501) and each passage is arranged in the same radial plane with respect to the long axis of central aperture (501). Each passage (530) is open to a bias housing (540) arranged circumferentially with respect to the central aperture (501) such that the passages (530) are between the bias housings (540) and the central aperture (501). Each of the four bias housings is arranged in the same radial plane with respect to the long axis of the central aperture (501).

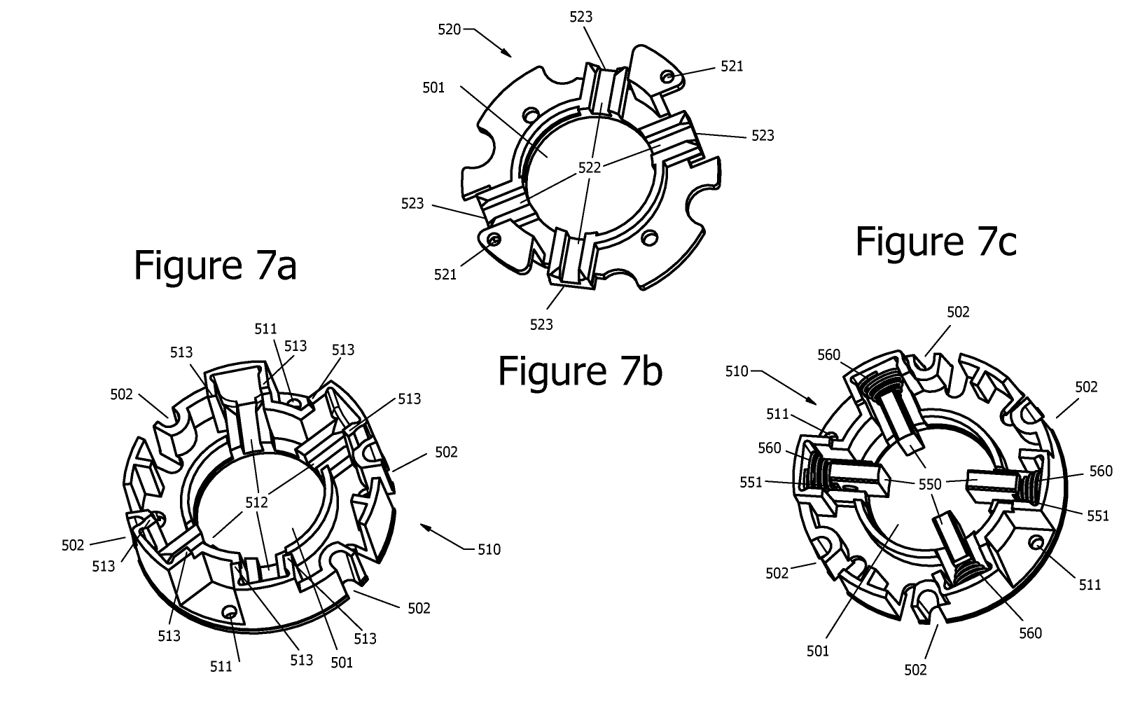

Brush housing (500) is formed from first part (510) and second part (520) which are joined together by fixing bolts (not shown) arranged through fixing holes (511, not shown as underneath 521, see FIGS. 7a) and (521) in the first and second parts respectively. The first and second parts (510) and (520) are formed from a polymeric material by moulding. The first and second parts (510) and (520) have complimentary profiles which when joined together form passages (530), each for receiving a brush, and bias housings (540), each for receiving a bias to urge said brush towards the central aperture (501). The second part (520) forms slots (541) in the brush housing (500) through which can be passed a compressed bias. The slots (541) are narrower than the bias housings (540) and therefore a compressed bias passed through the slots (541) can then expand into bias housing (540) and be retained therein whilst urging said brushes towards central aperture (501).

FIGS. 7a and 7b show the first part (510) and the second part (520) of the brush housing (500) respectively whereby the upper profile of first part (510) and the lower profile of second part (520) can be seen in more detail. First part (510) comprises open channels (512) and second part (520) comprises complimentary open channels (522). When the first (510) and second (520) parts are brought together to assemble the brush housing (500) the open channels (512) and (522) are brought into contact to form passages (530). First part (510) comprises abutments (513) and second part (520) comprises protruding square edge portions (523). When the first and second parts are brought together to form brush housing (500) the abutments (513) and the protruding square edge portions (523) are interengaged to form bias housings (540) with slots (541) for receiving compressed biases.

FIG. 7c shows the first part (510) comprising brushes (550) located in open channels (512) and biases (560) located in open channels (522) to illustrate the intended arrangement of brushes and biases in the assembled brush housing (500). The brushes (550) each comprise a lip (551) on the face of the brush arranged to contact the bias (560) at an upper end of said face, the lip being arranged to prevent lateral movement of the biases (560) in the bias housings (540) along the axis of the central aperture (501) and therefore prevent the biases (560) moving out of the bias housings (540) and/or out of contact with the brushes (550).

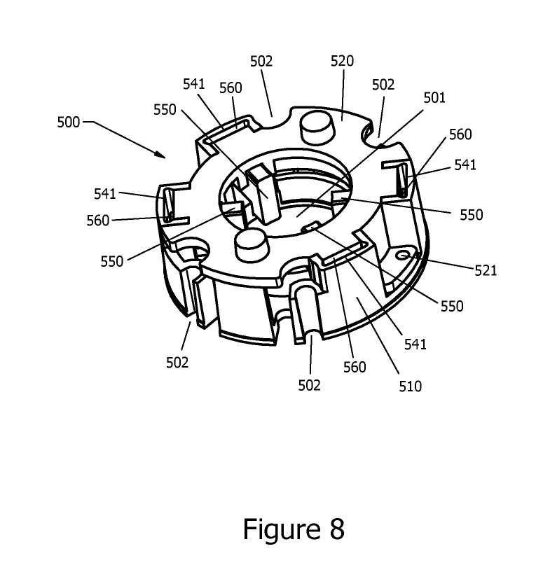

FIG. 8 shows brush housing (500) comprising four brushes (550) each located in a passage (530) and four biases (560) in the form of frustoconical springs each located in a bias housing (540). The biases (560) act to urge the brushes (550) towards the central aperture (501) of the brush housing (500).

The arrangement of the brush housing (500) greatly facilitates assembly of an electric motor incorporating the brush housing, specifically in the construction of a brush gear assembly comprising a brush housing, brushes and related biases. Such a brush gear assembly is assembled by fixing together the first part (510) and second part (520) by passing bolts through fixing holes (511) and (521) to provide a brush housing (500) with four passages (530) and four bias housings (540). Electrical cabling connecting the brushes to a brush electrical terminal may have already been arranged in the first part (510), for example through an aperture. A brush (550) is then placed in each of the passages (530) and pushed inwards towards bias housing (540). Alternatively, the brushes may be placed in the open channels (512) of the first part (510) before the first and second parts of the brush housing are fixed together. The brush housing comprising the brushes is then placed onto an armature which is received through central aperture (501). In order to urge the brushes into contact with the armature shaft (not shown) frustoconical springs (560) are compressed and passed through slots (541) into bias housings (540). Once in bias housing (540), the frustoconical springs (560) expand to urge the brushes into contact with the armature shaft, through a commutator, to complete the necessary electrical circuit in order for the brush gear to function in said electric motor. This arrangement of brush housing (500) allows a more straightforward and reliable assembly process than is possible with known brush housings.

Each of the framework (100) and the brush housing (500) allow a more straightforward assembly process which may result in significant cost savings in the manufacture of electric motors incorporating the framework (100) and the brush housing (500). The framework (100) and brush housing (500) also allow these parts to be manufactured from polymeric materials by moulding and therefore provide a significant cost saving in the material and manufacture cost of these parts and also provide a reduction in weight of an electric motor incorporating these parts. Both framework (100) and the brush housing (500) therefore provide significant improvements in relation to the manufacture and performance of electric motors, in particular starter motors.

Although a few preferred embodiments have been shown and described, it will be appreciated by those skilled in the art that various changes and modifications might be made without departing from the scope of the invention, as defined in the appended claims.

In summary, a framework is disclosed for holding magnets to provide a stator for an electric motor, in particular for a starter motor. The framework is adapted to removably receive, retain and space apart a plurality of magnets within the framework to form a tubular magnet array and provide said stator. The framework may provide a stator which is easier to assemble and more reliable than known stators. The framework provides a central aperture for receiving a rotor armature of said electric motor. The framework is arranged to be slidably inserted or removed from a housing of said electric motor. A frame portion, a stator, an electric motor, a vehicle drive assembly and a method of assembling an electric motor are also described. A brush housing comprising a plurality of passages for slidably retaining brushes and comprising a plurality of bias housings, and a brush assembly comprising the brush housing are also described.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A framework for holding magnets to provide a stator for an electric motor, wherein the framework is adapted to removably receive, retain and space apart a plurality of magnets within the framework to form a tubular magnet array adapted to accept a rotor armature arranged for rotation about a long axis of the framework, wherein the framework is arranged to slidably engage with a housing of said electric motor for insertion therein or removal therefrom.

2. (canceled)

3. The framework according to claim 2, wherein the plurality of frame portions comprises two frame portions, each of the two frame portions providing approximately half of the framework.

4. The framework according to claim 1, wherein the framework has a substantially cylindrical outer surface for sliding engagement with said housing.

5. The framework according to claim 1, wherein said magnets are curved and the framework is adapted to receive, retain and space apart said magnets to provide said tubular magnet array retained within the framework.

6. The framework according to claim 1, wherein the framework comprises a plurality of bays each adapted to receive, retain and space apart one of the said plurality of magnets.

7. The framework according to claim 6, wherein the bays are tapered to narrow from an outer surface of the assembled framework towards an inner surface of the framework.

8. (canceled)

9. The framework according to claim 1 wherein the framework is elastically deformable.

10. The framework according to claim 1, wherein the framework is shaped to accommodate elongate bolts extending substantially parallel to the long axis of the framework for assembling an electric motor incorporating the framework.

11. The framework according to claim 1, wherein the framework comprises apertures adapted to receive one or more electrical terminals for connection to one or more brushes.

12. The framework according to claim 11, wherein the framework and one of the apertures forms an electrical insulator portion for an electrical terminal in order to provide an insulated electrical terminal.

13-20. (canceled)

21. A stator comprising a framework according to claim 1 and a plurality of magnets received, retained and spaced apart within the framework to form a tubular magnet array.

22. An electric motor comprising:
a stator according to claim 21;
a brush housing comprising brushes, and
an armature comprising an armature shaft.

23. (canceled)

24. A vehicle drive assembly comprising an engine and an electric motor according to claim 22 configured as a starter motor for the engine.

25. (canceled)

26. (canceled)

27. A brush housing for an electric motor, the brush housing comprising:
a central aperture adapted to receive an armature comprising an armature shaft;
a plurality of passages, each passage arranged to slidably retain a brush at least partially extending into the central aperture for contacting said armature shaft; and
a plurality of bias housings, each bias housing arranged in communication with at least one of the plurality of passages through an opening and each bias housing arranged to receive and retain a bias for urging, through the opening, said brushes towards said armature shaft.

28. The brush housing according to claim 27, wherein each bias housing comprises a slot arranged on an outer surface of the brush housing through which a bias can be passed when compressed.

29. The brush housing according to claim 27, wherein the bias housings are each adapted to receive a conical or frustoconical spring as the bias.

30. The brush housing according to claim 27, wherein the passages are adapted to slidably receive brushes such that said brushes are arranged radially with respect to the central aperture.

31. The brush housing according to claim 27, wherein the bias housings are arranged outward from the passages with respect to the central aperture.

32. The brush housing according to claim 27, wherein the brush housing is formed from at least a first part and a second part and wherein the first and second parts are arranged to cooperate to retain said brushes and biases within their respective passages and bias housings.

33. A brush assembly comprising a brush housing according to claim 27; a plurality of brushes located in the passages; and a plurality of biases located in the bias housings.

34. An electric motor comprising a brush assembly according to claim 33, a stator and an armature shaft; wherein the biases bias the brushes against the armature shaft.

35. A method of assembling an electric motor, the method comprising the steps of:
a) providing a stator or stator framework having a plurality of brush electrical terminals, each comprising a brush attached thereto;
b) locating at least a first part of a brush housing according to claim 27 on the stator or stator framework;
c) arranging each of the brushes in a passage of the brush housing;
d) arranging an armature in the central aperture of the brush housing;
e) arranging a bias in each of the bias housings of the brush housing such that the biases urge the brushes towards and into contact with the armature.

36. The method according to claim 35, wherein after step c) and before step d) there is a step of joining a first part of the brush housing to a second part of the brush housing to retain the brushes in the passages.

37. The method according to claim 35, wherein the biases of step d) are conical or frustoconical springs.

38. (canceled)
